(19) United States
(12) Patent Application Publication
(10) Pub. No.: US 2022/0332528 A1
(43) Pub. Date: Oct. 20, 2022

(54) DRAWBRIDGE DOCKING SYSTEM

(71) Applicant: Zrii Technologies, Inc., North York (CA)

(72) Inventor: Varouj Shahbazian, Montreal (CA)

(21) Appl. No.: 17/232,453

(22) Filed: Apr. 16, 2021

(51) Int. Cl. B65G 69/28

(52) U.S. Cl. CPC B65G 69/2811

(57) ABSTRACT

A dockboard featuring a hinged dock plate with a simplified design resembling a draw bridge, with one portion being a stationary dock plate bolted flat on a dock top in an unobstructing disposition, and a second portion being a movable dock plate, fixably connected to the first portion with hinges, which may be raised or lowered to extend or retract a continuous load-supporting floor plane enabling horizontal access from the dock top to the receiving or discharging vehicle. When in an inoperative, retracted position, the second, movable dock plate is circumferentially rotated by means of the hinge connection to rest at a resting position angle of between 60 and 80 degrees from the first, stationary dock plate. When in an operative, extended position, the movable dock plate is circumferentially rotated by means of the hinge connection to rest at a resting position of 180 degrees from the stationary dock plate, forming a continuous plane with stationaly dock plate. The movable dock plate is sloped outward from its connection to the stationary plate, at the hinge, approximately ten degrees over its span, in order to create an easily traversable slope for users. The lip of the movable plate is tapered, in order that it also slope outward at approximately ten degrees over its span, to create an easily traversable slope to the receiving or discharging vehicle.

### FIELD

The subject disclosure generally relates to docking plates installed on dock tops to create a transition surface for ingress to and egress from shipping and delivery vehicles and more particularly to a docking plate with a simplified, drawbridge-style design.

### BACKGROUND

Docking plates are well known and are often used in shipping, receiving, and delivery areas of facilities of all kinds. Docking plates come in various sizes, styles, and configurations; most create a generally horizontal ramped transition surface for moving people and loading and unloading of materials from delivery vehicles into the facility with a minimum of difficulty.

Drawbacks and limitations exist in numerous of the docking plates currently known and available. Several popular models of docking plates are not fixed to the dock top. Such docking plates require personnel to lift the docking plate or plate, or to place the docking plates in between the dock top floor and the delivery vehicle as a bridge, or to reposition the docking plates as necessary during loading, unloading, and transit, and then subsequently remove and store. These docking plate options are cost-effective, but are cumbersome and difficult to lift, place, reposition and remove, and create a worker safety concern.

More expensive docking plate solutions involve hydraulic systems to lift, place, reposition if necessary, and remove the docking plate bridge between the dock top and the delivery vehicle. Such systems are safer and more effective than manual systems but are often prohibitively expensive and require maintenance and specialized training to operate. Accordingly, novel docking plate systems have been developed to reduce or alleviate some of these mechanical, personnel, and cost concerns.

For example, U.S. Patent No. 394067S to Wanddell discloses a horizontally hingedraiseable, extensible docking plate, wherein a docking plate bridge is raised from the dock top and extended, by a rolling guide and a hinged lip plate, to form a continuous load-supporting span throughout their combined extent from a vehicle platform to the dock top. Wanddell is a useable iteration but includes too many moving features and, raises the likelihood of wear. breakage, or mechanical failure. as well as being prohibitively expensive.

While the usefulness of known and available docking plates is well-known, improvements and/or alternatives are generally desired. It is therefore an object to provide a novel docking plate with a simplified, drawbridge-style design.

### SUMMARY

This summary provides a selection of concepts in a simplified form further described below in the detailed description of embodiments. The applicant does not intend this summary to be used to limit the scope of the claimed subject matter.

Accordingly, in one aspect there is provided a dockboard featuring a hinged dock plate with a simplified design resembling a drawbridge, with one plate portion being a stationary dock plate bolted flat on a dock top in an unobstructing disposition, and a second plate portion being a movable dock plate, fixably connected to the first portion with hinges, which may be raised or lowered to extend or retract a continuous floor plane giving horizontal access from the dock top to the adjacent receiving or discharging vehicle. When in an inoperative position. the second, movable dock plate rotates to rest at a resting position angle of between 60 and 80 degrees from the first stationary dock plate. When in an operative position, the movable dock plate rotates to rest at a circumferential resting position of 180 degrees from the stationary dock plate, forming a continuous load-supporting plane with stationary dock plate.

In one or more embodiments, the movable dock plate is sloped outward from its connection to the stationary plate, at the hinge. approximately ten degrees over its span, to create an easily traversable slope for users.

In one or more embodiments, the lip of the movable dock plate is tapered in order that it also sloped outward at approximately ten degrees over its span to create an easily traversable slope to the receiving or discharging vehicle.

In one or more embodiments, the stationary dock plate is bolted to the dock top with two or more bolts.

In one or more embodiments, the hinge connecting the movable plate to the stationary plate is an interleaving piano hinge. The stationary plate and the movable plate abut. at the hinge, when the movable plate is in its extended position. The vertical corner edge of the stationary plate closest to the hinge and the vertical corner edge of the movable plate closest to the hinge abut when the movable plate is in its retracted position.

In one or more embodiments, the angle of the movable plate in its extended position may be controlled by a rubber bumper affixed to the dock top. The movable plate in its retracted position may be controlled by use of a metal tie.

### BRIEF DESCRIPTION OF THE DRAWINGS

Embodiments will now be described more fully with reference to the accompanying drawings. in which:

FIG. 1 is a simplified overhead view of the movable dock plate with tapered lip;

FIG. 2 is a simplified side view of the moveable dock plate and the hinge pin;

FIG. 3 is a perspective schematic of the preferred embodiment of the dockboard of the present invention, shown mounted on a dock top in proximity to an adjacent delivery vehicle, and showing the dock top, the stationary plate affixed to the horizontal edge of the dock top, the movable plate rotating by means of the hinges to several positions along the axis of its rotation, the rubber bumper affixed to the vertical edge of the dock top, and the adjacent delivery vehicle with rubber stopper;

FIG. 4 is a top view of the stationary plate and the movable plate interleaving;

FIG. 5 is a top view of the moveable plate with tapered lip and hinges;

FIG. 6. is a bottom view of the stationary plate and the movable plate with hinge connections; and

FIG. 7 is a side view showing the slope of the movable plate.

### DETAILED DESCRIPTION OF EMBODIMENTS

The foregoing summary, as well as the following detailed description of certain embodiments will be better understood when read in conjunction with the accompanying drawings. As used herein. an element or feature recited in the singular and preceded by the word “a” or “an” should be understood as not necessarily excluding a plural of the elements of features. Further, references to “one example” or “one embodiment” are not intended to be interpreted as excluding the existence of additional examples or embodiments that also incorporate the recited elements or features of that one example or one embodiment.

Moreover, unless explicitly stated to the contrary, examples or embodiments “comprising,” “having” or “including” an element or feature or a plurality of elements or features having a particular property may further include additional elements or features not having that particular property. Also. it will be appreciated that the terms “comprises” “has” and “includes” means “including but not limited to” and the terms “comprising” “having” and “including” have equivalent meanings.

As used herein. the term “and/or” can include any and all combinations of one of more of the associated listed elements or features.

It will be understood that when an element or feature is referred to as being “on,” “attached” to, “connected” to, “coupled” with, “engaged” with, “contacting,” etc., another element or feature, that element or feature can be directly on, attached to, connected to, coupled with, engaged with or contacting the other element or feature or intervening elements may also be present. In contrast, when an element or feature is referred to as being, for example “directly on,” “directly attached” to, “directly connected” to, “directly coupled” with, “directly engaged” with or “directly contacting” another element or feature, there are no intervening elements or features present.

It will be understood that spatially relative terms, such as “under,” “below,” “lower,” “over,” “above,” “upper,” “front,” “back,” and the like, may be used he re in for ease of describing the relationship of an element or feature to another element or feature as depicted in the figures. The spatially relative terms can, however, encompass different orientations in use or operation in addition to the orientation depicted in the figures.

Reference herein to “example” means that one or more features, structures, elements, components characteristics and/or operational steps described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to.”

Unless otherwise indicated, the terms “first,” “second.” etc. are used here in merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third ” item).

As used herein, the terms “approximately” and “about” represent an amount close t o the stated amount that still performs the desired function or achieves the desired result. For example, the terms “approximately” and “about” may refer to an amount that is within engineering tolerances that would be readily appreciated by a person skilled in the art.

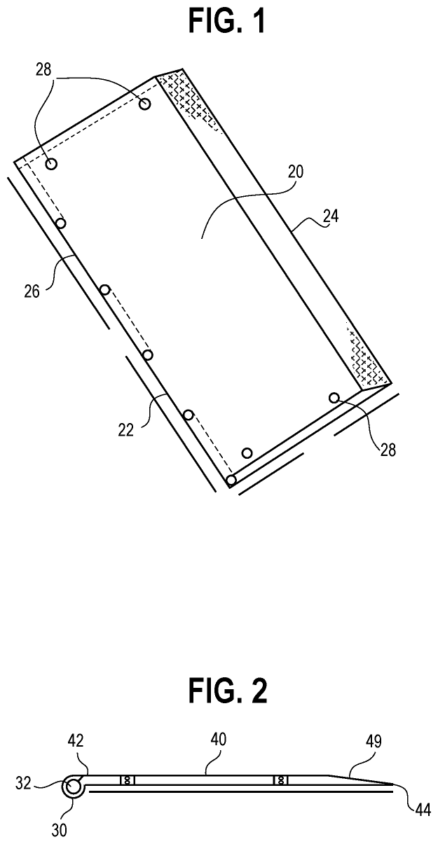

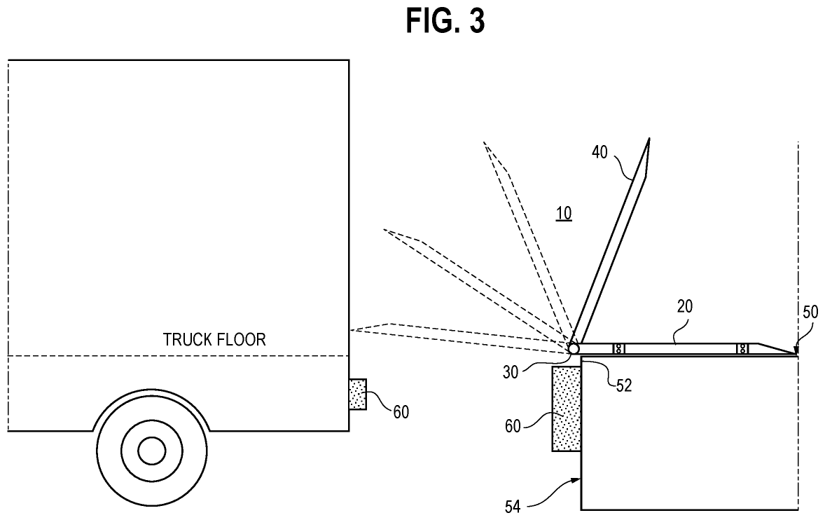

As shown in FIGS. 1-3, the drawbridge system 10 comprises a stationary plate 20, a hinge 30, and a movable dock plate 40. As shown in FIG. 1, the stationary dock plate 20 is a flat. rectangular metal dock plate, fabricated of aluminum or galvanized or stainless steel, or such other material as may be determined by one skilled in the art. As shown in FIGS. 1 and 3, the stationary dock plate 20 is disposed on the dock top 50 with an outer end portion 22 extending almost. but not entirely, to the outer edge 52 of the dock top 50, where the dock ends. The inner end portion 24 of the stationary dock plate 20 is supported by the dock top 50 and extends toward the building (not shown) of which the dock top 50 is a part. The stationary dock plate 20 is fixably attached to the dock top 50 by way of two or more bolts 28, at least one on each side of the stationary dock plate 20. T h e bolts 28 are as close to the margin of the stationary plate 20 as practicable to minimize interference with users traversing the drawbridge system 10 or dockboard, particularly where wheeled moving element s are in use.

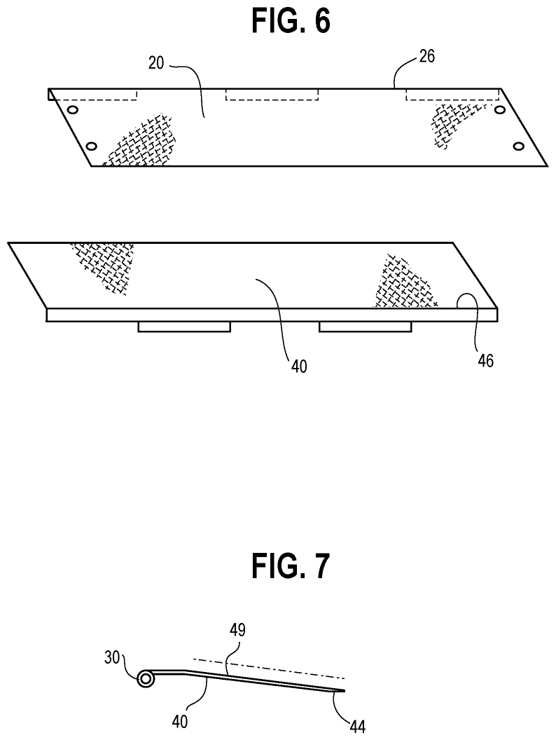

As shown in FIGS. 2 and 6, the hinge apparatus 30 consists of a hinge pin 32 and a number of hinges 34 and is located at the meeting point of. and fixably connected to, the stationary dock plate 20 and the movable dock plate 40. Three or more interleaving piano hinges 34 are pivotally connected to both the stationary plate 20 and the movable plate 40. The hinge pin 32 extends through the hinges 34 and spans the width of both the stationary plate 20 and the movable plate 40. The hinge pin 32 is a hardened, treated rod or pin fabricated of galvanized or stainless steel, or such other material as may be determined by one skilled in the art, to minimize wear and tear. The length of the hinge pin 3 2 will be coextensive with the width of the stationary 20 and movable 40 dock plates.

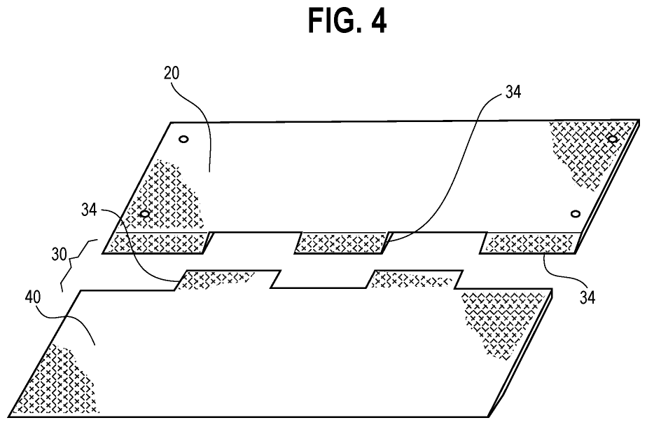

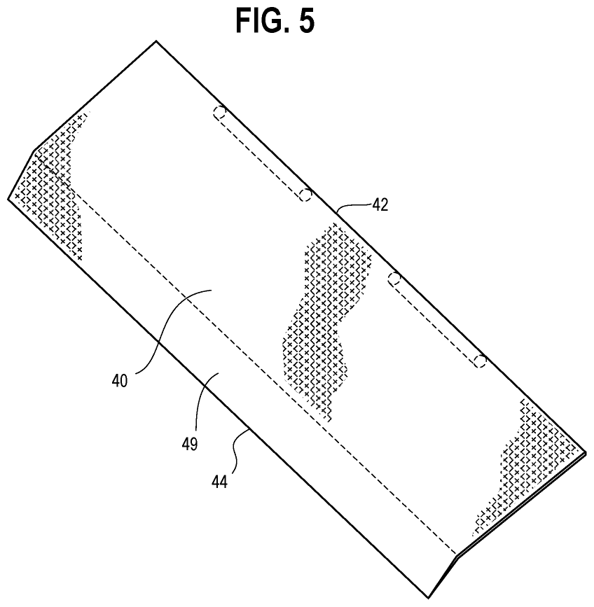

As shown in FIGS. 3-5, the movable plate 40 is a flat, rectangular metal dock plate, fabricated of aluminum orgalvanized or stainless steel, or such other material as may be determined by one skilled in the art. The movable dock plate 40 is disposed, in its retracted, inoperative position. rotated inward away from the dock top 50 by means of the hinge apparatus 30 at a circumferential angle of between 60 and 80 degrees from the stationary plate 20, and generally above the stationary plate 20 on the dock top 50. In its retracted, inoperative position, the inner end portion 42 of the movable plate 40 at its hinged connection 30 to the stationary plate 20 rests generally on the dock top 50, and its outer end portion 44 extending inward to the building side of the dock top 50 and is supported by the abutment of its vertical corner edge 4 6 with the vertical corner edge 26 of the stationary plate 20.

In its retracted, inoperative position, the movable plate 40 may be controlled by use of a metal tie (not shown) in the movable plate 40, which could be, for instance, looped through a bolt hole, or another alternative securing mechanism or materiel as may be determined by one skilled in the art.

As detailed in FIGS. 3 and 7, the movable dock plate 40 is sloped along its length, as considered outward from its connection at the inner portion 42 to the stationary plate 20 at the hinge 30, to its outward edge 44 toward the edge of the dock top 50 (when in its extended. operative position), approximately ten degrees from the horizontal over its span, thereby creating an easily traversable slope for users.

The movable dock plate 40 has a tapered lip 49 at its outward edge 44, in order that the lip also slopes outward and downward from the horizontal, at approximately ten degrees over its span. thereby creating an easily traversable slope at the immediate connection to the receiving or discharging vehicle.

As shown in FIG. 3 rubber stopper 60 or bumper may be affixed to the outward. vertical face of the dock top 54. The resting angle of the movable plate 40 in its extended position may be controlled by use of the rubber stopper 60 or bumper so affixed.

Alternatively, the rubber stopper may be duplicated or reciprocally affixed to the back of the vehicle being loaded or unloaded. In typical operation, the movable plate 40 will be retracted from its extended position before the receiving or discharging vehicle departs from the dock, and therefore concerns about restraining the further movement of the movable plate beyond the horizontal plane defined by the dock top.

In the preferred embodiment illustrated in the accompanying drawings, the dockboard 10 is shown mounted on a dock top 50, extending in its operative position to provide a continuous, load-supporting surface extending between a dock top and an adjacent vehicle, and retracting to move to its retracted, inoperative position. wherein the dockboard “bridge” is removed.

As so constructed, the dockboard 10 is rotationally movable from a retracted, inoperative position wherein the movable dock plate 40 is rotated inward away from the dock top 50 b y means of the hinge apparatus 3 0 at a circumferential angle of between 60 and 80 degrees from the stationary plate, and generally above the stationary plate 20 on the dock top 50, to an extended, operative position wherein the movable dock plate 40 has been rotated circumferentially from its retracted position to an extended position where the movable plate extends and provides a continuous, load-supporting surface extending between a dock top 50 and an adjacent vehicle.

The hinge apparatus 3 0 guides the rotational movement of the movable plate circumferentially from the retracted, inoperative position of the movable plate in a substantially vertical path outward and away from the stationary plate, extending from the dock top 50 into the space beyond the dock top, allowing the movable plate 40 to rotate from its retracted, inoperative position to its extended, operative position. In its extended, operative position, the inner end portion 42 of the movable plate 40 rests on and remains partially supported by the dock top 50, and the rubber stopper 60 and the adjacent vehicle platform. The movable plate 40 therefore hingedly depends on the stationary plate 20 and the portion of the supporting dock top 50, such that when rotated in to its extended, operative position, the movable 40 plate and the stationary plate 20 together form a continuous, load-supporting span throughout their combined extent from a vehicle platform to the dock top.

Both the stationary dock plate 20 and the movable dock plate 40 are made of flat, heavy steel that may be supported in their inoperative position by the dock top 50, together with the connection of the two plates at the hinge 30 at their vertical top corner edge; and, in their operative position, by a combination of the dock top 50, the rubber dock top stopper 60, and the adjacent vehicle floor.

When the dockboard is desired for use, the movable plate 40 may be detached by handfrom its controlling feature, such as a metal tie (not shown) or other controlling feature as may be determined by one skilled in the art, from its retracted, inoperative position, and rotated circumferentially in a generally upward and outward direction to its extended, operative position approximately 180 degrees from the stationary plate 20, with which it abuts in its extended, operative position. When it is desired to return the dockboard 10 to its retracted, inoperative position from its extended, operative position, the movable dock plate 40 may be raised by hand to rotationally retract and return to its retracted, inoperative position.

Although embodiments have been described above and are shown in the accompanying drawings, it will be appreciated by those skilled in the art that variations and modifications may be made without departing from the scope as defined by the appended claims, and the scope of the claims should be given the broadest interpretation consistent with the specification as a whole.

I claim:

1. A drawbridge dockboard for transiting materials to and from a dock, the dockboard comprising:
a) a first plate portion attached to and in a stationary, fixed position relative to the dock;
b) a second plate portion comprising a manually powered movable dockplate; and
c) a hinge connecting the first plate portion and the second plate portion, wherein the second plate is movable from an inoperative position to an operative position, wherein the inoperative position is raises the second plate portion to an acute angle relative to the first plate portion, and the operative position is a lowered position providing a substantially horizontal continuous floorplane from the dock to an adjacent vehicle so as to provide a continuous load supporting plane from the dock to the vehicle.

2. The drawbridge dockboard of claim 1, wherein the inoperative position of the second plate portion is at an angle of between 60 and 80 degrees from the first plate portion.

3. The drawbridge dockboard of claim 1, wherein the second plate comprises a proximate end adjacent the hinge and a distal end closest to the vehicle, where the second plate portion is sloped downward from the proximate end to the distal end to provide a more readily traversable path between the vehicle and the dock.

4. The drawbridge dockboard of claim 1, wherein the first plate portion is bolted to the dock with a plurality of bolts.

5. The drawbridge dockboard of claim 1, further comprising a rubber bumper fixed to the dock whereby the operative position of the second plate portion is controlled by the rubber bumper.

6. The drawbridge dockboard of claim 1, further comprising a metal tie whereby the inoperative position of the second plate portion is controlled by the metal tie.

7. The drawbridge dockboard of claim 1, wherein the hinge is an interleaving piano hinge.

8. A method of providing a manually powered, retractable continuous, load-supporting surface extending between a dock top and an adjacent vehicle, the method comprising the steps of:
a) Bolting a first plate portion a dock in a stationary, fixed position relative to the dock top;
b) Lowering a movable second plate portion attached by a hinge to the first plate portion, wherein the step of lowering occurs in the presence of an adjacent vehicle to provide a continuous load bearing, substantially horizontal plane between the dock top and the adjacent vehicle; and
c) Manually raising the movable second plate portion to a disengaged position to form an acute angle relative to the first plate portion in the absence of an adjacent vehicle.

9. The method of providing a manually powered, retractable continuous, load-supporting surface extending between a dock top and an adjacent vehicle as called for in claim 8, wherein the step of manually raising the movable second plate portion is controlled by a metal tie.

10. The method of providing a manually powered, retractable continuous, load-supporting surface extending between a dock top and an adjacent vehicle as called for in claim 8, wherein the step of lowering the movable second plate portion is limited by a rubber bumper affixed to the dock.

11. The method of providing a manually powered, retractable continuous, load-supporting surface extending between a dock top and an adjacent vehicle as called for in claim 8, wherein the step of lowering the movable second plate portion further includes lowering a tapered edge of the movable second plate portion so as to provide an approximately 10 degree slope relative to ground for the continuous load bearing, substantially horizontal plane between the dock top and the adjacent vehicle.
